(19) United States
(12) Patent Application Publication
(10) Pub. No.: US 2014/0007120 A1
(43) Pub. Date: Jan. 2, 2014

(54) METHOD FOR OPERATING A MICROPROCESSOR UNIT, IN PARTICULAR IN A MOBILE TERMINAL

(71) Applicant: Stephan Spitz, Karlsfeld (DE)

(72) Inventor: Stephan Spitz, Karlsfeld (DE)

(73) Assignee: TRUSTONIC LIMITED, CAMBRIDGE (UK)

(21) Appl. No.: 14/001,361

(22) PCT Filed: Feb. 22, 2012
(86) PCT No.: PCT/EP12/00765

§ 371 Date: Sep. 17, 2013

(30) Foreign Application Priority Data
Feb. 24, 2011 (DE) 102011-012226.5

(51) Int. Cl. G06F 9/44

(52) U.S. Cl. CPC G06F 9/44
USPC 718/102

(57) ABSTRACT

The invention relates to a method for operating a microprocessor unit, in particular in a mobile terminal, wherein the microprocessor unit comprises a microprocessor (MP) on which a normal runtime environment (NZ) is implemented with a first operating system (B1) and a secure runtime environment is implemented with a second, secure operating system (B2). The microprocessor unit also comprises a RAM memory (R) outside the secure runtime environment (TZ), into which memory the first operating system (B1) is loaded when executing the normal runtime environment (NZ). The invention is distinguished by the fact that the second operating system (B2) is a secure version of the first operating system (B1), which version is loaded into a section of the RAM memory intended for the secure runtime environment during the execution of the secure runtime environment (TZ).

The invention relates to a method for operating a microprocessor unit, particularly in a mobile terminal, and also to an appropriate microprocessor unit and an appropriate mobile terminal.

The prior art discloses the implementation of what is known as a protected runtime environment in a microprocessor unit in order to execute security-critical applications in an isolated environment. In this case, a microprocessor unit is intended to be understood to mean all of the hardware used for executing the applications, particularly the actual microprocessor and appropriate memories that are used for storing data.

Conventional protected runtime environments usually use an operating system with low memory requirements, such as the MobiCore® operating system known from the prior art, which is used in combination with a protected runtime environment in the form of what is known as the ARM TrustZone®. In this case, the operating system used in the protected runtime environment is loaded into an internal RAM store within the protected runtime environment. Since the internal RAM store is of limited size, the operating system used in the protected runtime environment must be a small size, which means that the scope of functions provided by the microprocessor unit is small when the protected runtime environment is executed. This is not a problem so long as only security-critical tasks are transmitted to the protected runtime environment. In particular instances of application, however, it may be necessary for a protected runtime environment with a relatively large scope of functions, too, to be provided by the microprocessor unit. If the microprocessor unit is used in a cell phone, for example, protection against eavesdropping attacks preferably requires the provision of a protected runtime environment that can be used for the voice call functionality of the cell phone. This cannot be achieved by current operating systems that are used in protected runtime environments.

It is therefore an object of the invention to operate a microprocessor unit such that a protected runtime environment with a larger scope of functions than in the prior art is provided.

This object is achieved by the method according to patent claim 1 and the microprocessor unit according to patent claim 8 and the mobile terminal according to patent claim 10. Developments of the invention are defined in the dependent claims.

The method according to the invention is used for operating a microprocessor unit that comprises a microprocessor, on which a normal runtime environment having a first operating system and a protected runtime environment having a second, protected operating system are implemented. In this case, the microprocessor unit also contains a RAM store outside the protected runtime environment, into which RAM store the first operating system is loaded when the normal runtime environment is executed. The first operating system is particularly an inherently known operating system for a microprocessor unit, e.g. a cell phone operating system if the microprocessor unit is used for a cell phone. Examples of such cell phone operating systems are Android or Symbian, which are used for smartphones and provide a large scope of functions.

The method according to the invention is distinguished in that the second operating system is a protected version of the first operating system that, in the course of the execution of the protected runtime environment, is loaded into a section of the RAM store that is provided for the protected runtime environment. In this case, the protected version of the first operating system is particularly what is known as a hardened operating system. The term “hardening” is sufficiently well known from computer engineering and denotes increasing the security of a system, such as a program or an operating system, by using only particular software that is necessary for operating the system and for which there is the assurance that it runs correctly while taking account of security aspects.

According to the invention, therefore not only the original first operating system but also a second operating system, which meets higher security requirements, is used. Usually, the scope of functions over the protected or hardened operating system is reduced in comparison with the original operating system in this case, but is distinctly greater than that of a conventional operating system (such as MobiCore®) provided for a protected runtime environment, which means that more memory is also required. The invention takes account of this by virtue of the second protected operating system being loaded into a RAM store outside the protected runtime environment, since this memory may be of substantially larger design than an internal RAM store within the protected runtime environment.

In one particularly preferred embodiment of the method according to the invention, the second operating system is loaded into a RAM store in the form of an OnSoC RAM (SOC=System on a Chip). In this case, an OnSoC RAM is monolithically integrated in a chip together with the other constituent parts of the microprocessor unit. In one preferred embodiment, the OnSoC RAM is coupled to the microprocessor of the microprocessor unit by means of the inherently known AMBA bus (AMBA=Advanced Microcontroller Bus Architecture).

In a further, particularly preferred embodiment of the method according to the invention, the microprocessor unit is controlled by means of a switch that a user can use to change between the execution of the normal and protected runtime environments. In this way, the user can stipulate the mode in which he can operate the microprocessor unit. If the user uses the microprocessor unit in a security-critical environment, for example, he can switch from the first, unprotected operating system to the second, protected operating system. In this case, the second operating system provides a larger scope of functions than a conventional protected runtime environment, in which the operating system is loaded into an internal RAM store of the protected runtime environment.

In a further preferred embodiment, an indicator unit is used to indicate to a user when the protected runtime environment is being executed, as a result of which the user is always informed about the mode in which he is currently operating the microprocessor unit.

In a further, particularly preferred embodiment of the method according to the invention, the microprocessor unit is provided for a cell phone and contains a baseband processor for processing communication functionalities. In order to ensure that particular communication functionalities are provided even when the protected runtime environment is being executed, a portion of the communication functionalities of the baseband processor is implemented in the second operating system in this embodiment. Preferably, the voice call function or the SMS function or both functions is/are implemented as communication functionalities of the baseband processor in this case, as a result of which the user can use at least basic functionalities of the cell phone.

In a further, particularly preferred embodiment of the method according to the invention, the protected runtime environment is implemented on the basis of inherently known hardware in the form of what is known as an ARM TrustZone®. In contrast to conventional methods, a protected or hardened operating system that is derived from an operating system provided for the normal runtime environment is now used in the TrustZone instead of the MobiCore® operating system that is usually used.

Besides the method described above, the invention also relates to a microprocessor unit, particularly for a mobile terminal, comprising a microprocessor, on which a normal runtime environment having a first operating system and a protected runtime environment having a second operating system are implemented, and also a RAM store outside the protected runtime environment, into which RAM store the first operating system is loaded when the normal runtime environment is executed. The microprocessor unit is distinguished in that the second operating system is a protected or hardened version of the first operating system and a section of the RAM store is provided for the second operating system, into which section the second operating system is loaded in the course of the execution of the protected runtime environment.

Preferably, the microprocessor unit is designed such that one or more of the preferred variants of the method according to the invention that are described above can be implemented on the microprocessor unit.

Furthermore, the invention relates to a mobile terminal, particularly a cell phone, which comprises the microprocessor unit according to the invention or one or more preferred variants of the microprocessor unit according to the invention.

Exemplary embodiments of the invention are described below in detail with reference to the appended figures, in which:

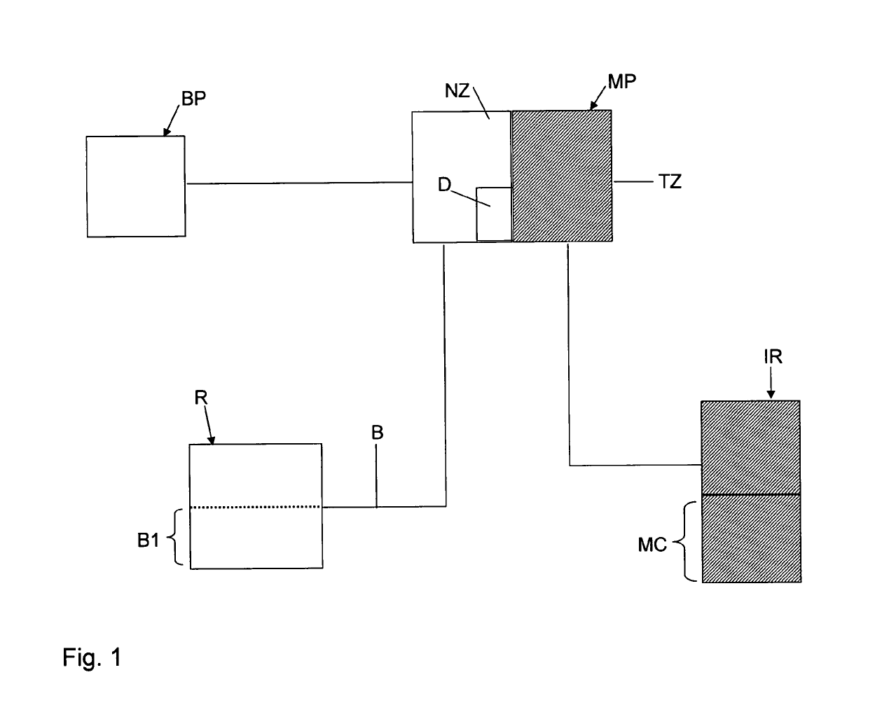

FIG. 1 shows an implementation of a protected runtime environment in a microprocessor unit based on the prior art; and

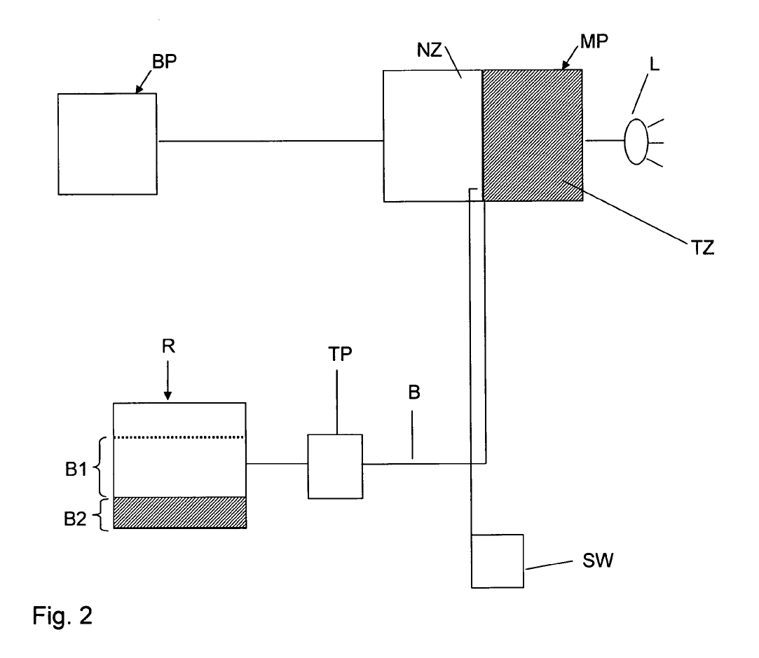

FIG. 2 shows an implementation of a protected runtime environment based on an embodiment of the invention.

The method according to the invention is described below on the basis of a microprocessor unit that is provided for a cell phone, the method also being able to be used for microprocessor units in other mobile appliances, however. In this case, the microprocessor unit is implemented in the form of what is known as SoC or signal-chip system (SoC=System on a Chip), i.e. essentially all the components of the microprocessor unit are integrated on a single IC chip.

FIG. 1 shows the design of a single-chip system in which a protected runtime environment is implemented in conventional fashion. In this case, the chip contains the actual microprocessor MP, which is an ARM microprocessor, on which a protected runtime environment in the form of a TrustZone, denoted by TZ, is implemented in a manner that is known per se. In FIG. 1 and also in FIG. 2, which is described further below, regions having a protected runtime environment are always shown in shaded form in this case. For operating the protected runtime environment TZ, the inherently known MobiCore® operating system is used in FIG. 1. Security-critical functions, such as mobile payment applications or other applications that require access to personal user-specific data, are relocated to the protected runtime environment. During operation of the TrustZone TZ, the MobiCore® operating system is loaded into an internal RAM store within the TrustZone, said RAM store being denoted by IR in FIG. 1. The section of the RAM store that contains the operating system MobiCore® is denoted by MC in this case. The reference symbol MC is subsequently also used to denote the MobiCore® operating system.

Besides the protected runtime environment TZ, the microprocessor MP also contains a normal runtime environment, which is denoted by NZ in FIG. 1. This stores the conventional operating system of the microprocessor unit, which operating system has much greater memory requirements than the MobiCore® operating system. In the embodiment described, this operating system is what is known as a richOS with a large scope of functions, as used in smartphones, for example. An example of such an operating system is the cell phone operating system Android.

During the execution of the normal runtime environment, the RAM store R is used in the microprocessor unit in FIG. 1, said RAM store being in the form of an OnSoC RAM on the chip and being linked to the microprocessor MP by means of the inherently known AMBA bus B. In this case, the conventional rich OS operating system is loaded into this RAM store. In FIG. 1, the section of the RAM store that contains the richOS operating system is denoted by B1. This reference symbol is subsequently also used to denote the rich OS operating system.

Besides the microprocessor MP, the microprocessor unit in FIG. 1 also contains what is known as a baseband processor BP that is used to implement the communication functionalities of the cell phone. The baseband processor BP therefore communicates with the SIM/USIM card of the cell phone and also the mobile radio network and possibly also with a microphone.

In order to operate the microprocessor in FIG. 1 in the secure mode in the TrustZone TZ, a MobiCore® driver D, which initiates the change to the protected runtime environment, is provided within the normal zone NZ. In the course of the execution of the protected runtime environment, only the internal RAM store IR, which has only a limited storage volume (approximately 128 kB), is used, as shown in FIG. 1. Accordingly, the scope of functions of the MobiCore® operating system MC is much smaller than that of a rich OS, which is loaded into the OnSoC RAM store R, which is of distinctly larger design and usually has several Mbytes of storage volume.

On account of the small scope of functions of MobiCore®, only security-critical tasks can be delegated to the protected runtime environment. Hence, no further functionalities of the microprocessor unit can be used during the execution of the protected runtime environment. This is disadvantageous because in particular scenarios it is desirable for more functions of the conventional operating system, such as the voice call functionality, also to be controlled in the course of the execution of the protected runtime environment. In particular, operation on the basis of a protected runtime environment should be possible in the case of attack scenarios in the public sector environment, such as in the case of eavesdropping on telephones. MobiCore® cannot ensure protection for such attack scenarios, since the voice call functionality is not provided when the MobiCore® operating system is executed.

FIG. 2 shows an embodiment of a microprocessor unit according to the invention that is used to solve the problems addressed above. In this case, the same reference symbols are used for components that correspond to components in FIG. 1. In a similar manner to FIG. 1, the microprocessor unit in FIG. 2 comprises a microprocessor MP having a TrustZone TZ and a normal zone NZ. Similarly, a baseband processor BP and also the OnSoC RAM store R are again provided. In contrast to the embodiment of FIG. 1, the TrustZone is now no longer executed on the basis of the MobiCore® operating system, but rather a hardened variant of the conventional rich OS operating system B1 is used for this. In this case, the hardened operating system, which is denoted by B2 in FIG. 2, has a smaller scope of functions than the operating system B1, but now contains distinctly more functions than the pure MobiCore® operating system. The term “hardening” has already been described further above and relates to the reduction of the scope of functions of an operating system so as thereby to increase the security thereof toward attacks from unauthorized third parties. The hardened operating system is therefore an operating system with a reduced scope of functions that is protected in comparison with the original operating system.

According to the embodiment in FIG. 2, this hardened operating system B2 is now used during the operation of the TrustZone TZ, but to this end it is no longer loaded into the internal RAM store IR, but rather is loaded into the OnSoC RAM store R, since the internal RAM store is no longer adequate for the hardened operating system B2. In the embodiment shown in FIG. 2, the hardened operating system also incorporates particular communication functionalities of the baseband processor BP, particularly the voice call functionality of the baseband processor BP. This is indicated by a shaded region within the baseband processor BP. In this case, the hardened operating system contains the relevant drivers for communication via the baseband processor BP.

Depending on the instance of application, the microprocessor unit shown in FIG. 2 allows the use both of the normal operating system B1 and of the hardened operating system B2. When the microprocessor unit is started or booted, what is known as a TrustZone protection controller TP is then used that accesses the RAM store R via the AMBA bus and is configured such that a portion of the OnSoC RAM store R is available exclusively for the execution of the TrustZone TZ. Although the security of the OnSoC RAM store partitioned by means of this TrustZone protection controller is not as high as that of the internal RAM store IR, the security is adequate for protecting a complete hardened operating system. An appropriate switch SW also allows the use of the cell phone to change over between the conventional operating system B1 and the hardened operating system B2. In this case, the microprocessor unit in FIG. 2 also contains an indicator unit L in the form of an LED, the lighting of the LED signaling to the user of the cell phone that he is in the protected mode in which the hardened operating system is executed.

The embodiment the invention described in the above has a series of advantages. In particular, a user of the microprocessor unit or of the relevant cell phone is then able to select or change between two modes of operation of the cell phone in an appliance. Firstly, he can use the cell phone in the unprotected mode on the basis of the operating system B1, in which case he has the opportunity to use the advantages of established richOS operating systems, such as downloading applications, using GPS for navigation and the like. If, by contrast, protected operation of the cell phone is necessary, the user can change to the secure mode, in which the cell phone is operated with the hardened operating system B2. In this case, the user no longer has all the functionalities of the cell phone available, but the cell phone is protected against attacks from third parties. Unlike when the MobiCore® operating system shown in FIG. 1 is used, the scope of functions of the telephone in the secure mode is larger, however. In particular, the voice call functionality continues to be ensured by the cell phone. According to the invention, the use of the hardened operating system in a protected runtime environment allows a complete cell phone operating system, such as the aforementioned operating system Android, to be protected. In this case, the invention is particularly suitable for applications (e.g. in the public sector environment, in the case of eavesdropping attacks) that require a higher level of security than software virtualization based on MobiCore®, but do not necessarily have to use an internal RAM store for security.

1. A method for operating a microprocessor unit, particularly in a mobile terminal, wherein the microprocessor unit comprises a microprocessor (MP), on which a normal runtime environment (NZ) having a first operating system (B1) and a protected runtime environment having a second operating system (B2) are implemented, and also a RAM store (R) outside the protected runtime environment (TZ), into which RAM store the first operating system (B1) is loaded when a normal runtime environment (NZ) is executed;
characterized in that
the second operating system (B2) is a protected version of the first operating system (B1) that, in the course of the execution of the protected runtime environment (TZ), is loaded into a section of the RAM store (R) that is provided for the protected runtime environment (TZ).

2. The method as claimed in claim 1, characterized in that the second operating system (B2) is loaded into a RAM store (R) in the form of an OnSoC RAM, wherein the OnSoC RAM is coupled to the microprocessor (MP) particularly by means of an AMBA bus (B).

3. The method as claimed in claim 1, characterized in that the microprocessor unit is controlled by means of a switch (SW) that a user can use to change between the execution of the normal and protected runtime environments (NZ, TZ).

4. The method as claimed in claim 1, characterized in that an indicator unit (L) is used to indicate to a user when the protected runtime environment (TZ) is being executed.

5. The method as claimed in claim 1, characterized in that the microprocessor unit is provided for a cell phone and contains a baseband processor (BP) for processing communication functionalities, wherein a portion of the communication functionalities of the baseband processor (BP) is implemented in the second operating system.

6. The method as claimed in claim 5, characterized in that the voice call function and/or the SMS function are implemented in the second operating system as communication functionalities of the baseband processor (BP).

7. The method as claimed in claim 1, characterized in that the protected runtime environment (TZ) is an ARM TrustZone®.

8. A microprocessor unit, particularly for a mobile terminal, comprising a microprocessor (MP), on which a normal runtime environment (NZ) having a first operating system (B1) and a protected runtime environment (TZ) having a second operating system (B2) are implemented, and a RAM store (R) outside the protected runtime environment (TZ), into which RAM store the first operating system (B1) is loaded when the normal runtime environment (NZ) is executed; characterized in that
the second operating system (B2) is a protected version of the first operating system (B1) and a section of the RAM store (R) is provided for the second operating system (B2), into which section the second operating system (B2) is loaded in the course of the execution of the protected runtime environment (TZ).

9. The microprocessor unit as claimed in claim 8, characterized in that the microprocessor unit comprises a microprocessor (MP), on which a normal runtime environment (NZ) having a first operating system (B1) and a protected runtime environment having a second operating system (B2) are implemented, and also a RAM store (R) outside the protected runtime environment (TZ), into which RAM store the first operating system (B1) is loaded when a normal runtime environment (NZ) is executed;
characterized in that the second operating system (B2) is a protected version of the first operating system (B1) that, in the course of the execution of the protected runtime environment (TZ), is loaded into a section of the RAM store (R) that is provided for the protected runtime environment (TZ), characterized in that the second operating system (B2) is loaded into a RAM store (R) in the form of an OnSoC RAM, wherein the OnSoC RAM is coupled to the microprocessor (MP) particularly by means of an AMBA bus (B).

10. A mobile terminal, particularly a cell phone, characterized in that the mobile terminal comprises a microprocessor unit according to claim 8.
